(19) United States
(12) Patent Application Publication
(10) Pub. No.: US 2022/0397905 A1
(43) Pub. Date: Dec. 15, 2022

(54) INFORMATION PROCESSING APPARATUS, INFORMATION PROCESSING METHOD, AND PROGRAM

(71) Applicant: SONY GROUP CORPORATION, TOKYO (JP)

(72) Inventor: KEIJI MURO, TOKYO (JP)

(21) Appl. No.: 17/756,146

(22) PCT Filed: Nov. 13, 2020
(86) PCT No.: PCT/JP2020/042382

§ 371 Date: May 18, 2022

(30) Foreign Application Priority Data
Nov. 28, 2019 (JP) 2019-214806

(51) Int. Cl. G05D 1/02

(52) U.S. Cl. CPC G05D 1/0214

(57) ABSTRACT

An information processing apparatus according to an embodiment of the present technology includes a sub-goal arranging unit and a prohibited-area generating unit. The sub-goal arranging unit arranges a sub-goal on the basis of position information of a set destination, map information of a travel environment of a mobile apparatus, and self-position information of the mobile apparatus. The prohibited-area generating unit generates, in at least a portion of a periphery of the destination, a prohibited area where arrangement of the sub-goal is prohibited.

### TECHNICAL FIELD

The present technology relates to an information processing apparatus, an information processing method, and a program for controlling an autonomous-type mobile apparatus.

### BACKGROUND ART

In recent years, autonomous-type mobile apparatuses including, for example, self-driving cars, robots, and the like have been actively developed. In order for such a mobile apparatus to move following a predetermined route to a destination, it is necessary move the mobile apparatus while avoiding obstacles on the route.

For example, Patent Literature 1 has disclosed an autonomous movable object as such a technology, the autonomous movable object including an action selection unit that calculates the size of a found obstacle and selects a stopping or reversing action on the basis of the size of a space in which the autonomous movable object is travelling, the size of the autonomous movable object, and the size of the obstacle and being capable of suitably performing the stopping or reversing action in accordance with a situation in a case where there is an obstacle that can interfere with the autonomous movable object.

### CITATION LIST

### Patent Literature

Patent Literature 1: Japanese Patent Application Laid-open No. 2012-22467

### DISCLOSURE OF INVENTION

### Technical Problem

This kind of mobile apparatus is required to arrive at a destination in a predetermined attitude. However, in a case where the action is selected on the basis of the size of an obstacle on a passageway as in the technology described in Patent Literature 1, if an obstacle is present at a particular place such as a destination, there is a possibility that the mobile apparatus cannot arrive at the destination in the predetermined attitude as a result of making a detour near the destination, for example.

In view of such circumstances, it is an objective of the present technology to provide an information processing apparatus, an information processing method, and a program that enable a mobile apparatus to arrive at a destination in a predetermined attitude.

### Solution to Problem

An information processing apparatus according to an embodiment of the present technology includes a sub-goal arranging unit and a prohibited-area generating unit.

The sub-goal arranging unit arranges a sub-goal on the basis of position information of a set destination, map information of a travel environment of a mobile apparatus, and self-position information of the mobile apparatus.

The prohibited-area generating unit generates, in at least a portion of a periphery of the destination, a prohibited area where arrangement of the sub-goal is prohibited.

The prohibited-area generating unit may be configured to generate the prohibited area in a case where an obstacle is present on the destination.

The prohibited-area generating unit may be configured to remove the prohibited area in a case where an obstacle on the destination has been removed.

The prohibited-area generating unit may be configured to generate the prohibited area so that a sub-goal that moves the mobile apparatus in a direction away from the destination before the mobile apparatus arrives at the destination from the sub-goal is not arranged.

The prohibited-area generating unit may be configured to generate the prohibited area so that the mobile apparatus is capable of arriving at the destination in a prescribed attitude.

The information processing apparatus may further include: a general-route planning unit that plans a general route to the destination on the basis of the position information of the destination; and a local-route planning unit that plans a local route to the sub-goal arranged by the sub-goal arranging unit.

The sub-goal arranging unit may be configured to generate a plurality of sub-goal candidates arranged in a horizontal direction orthogonal to a travel direction of the mobile apparatus as the sub-goal, and the local-route planning unit may be configured to select one sub-goal candidate from the plurality of sub-goal candidates.

The local-route planning unit may select a sub-goal candidate of the plurality of sub-goal candidates, which provides a shortest route to the destination.

The information processing apparatus may be provided in the mobile apparatus.

An information processing method according to an embodiment of the present technology includes:

arranging a sub-goal on the basis of position information of a set destination, map information of a travel environment of a mobile apparatus, and self-position information of the mobile apparatus; and

generating, in at least a portion of a periphery of the destination, a prohibited area where arrangement of the sub-goal is prohibited.

A program according to an embodiment of the present technology causes a computer to execute:

a step of arranging a sub-goal on the basis of position information of a set destination, map information of a travel environment of a mobile apparatus, and self-position information of the mobile apparatus; and

a step of generating, in at least a portion of a periphery of the destination, a prohibited area where arrangement of the sub-goal is prohibited.

### BRIEF DESCRIPTION OF DRAWINGS

FIG. 1 A schematic configuration diagram of a mobile apparatus according to an embodiment of the present technology.

FIG. 2 A functional block diagram of a controller in the mobile apparatus.

FIG. 3 A flowchart showing an example of processing performed in the controller.

FIG. 4 An explanatory diagram of actions of the controller.

FIG. 5 An explanatory diagram of actions of the controller.

FIG. 6 An explanatory diagram of actions of the controller.

### MODE(S) FOR CARRYING OUT THE INVENTION

Hereinafter, an embodiment according to the present technology will be described with reference to the drawings.

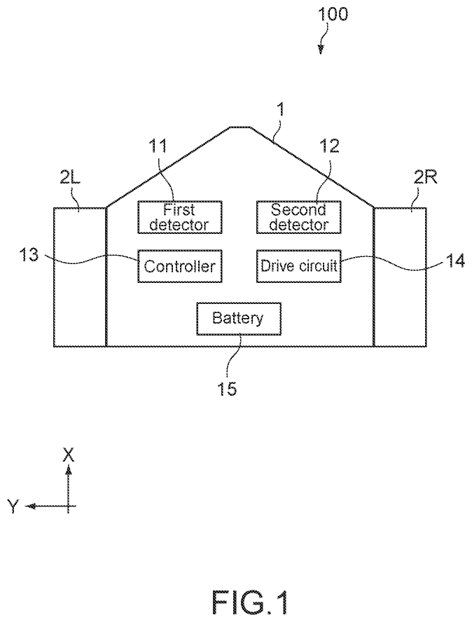

FIG. 1 is a schematic configuration diagram of a mobile apparatus according to the embodiment of the present technology. A mobile apparatus 100 according to this embodiment is configured as a two-wheel differential drive-type robot having a body 1 and wheels (right wheel 2R and left wheel 2L), which is an autonomous movable object. It should be noted that the present technology is not limited thereto, and the present technology can also be applied to another autonomous movable object such as a walking robot and a drone.

The X- and Y-axes in FIG. 1 indicate front-rear and left-right directions of the mobile apparatus 100, respectively, and the upper side in the figure corresponds to a front side of the mobile apparatus 100. The mobile apparatus 100 is configured to be autonomously movable to a destination along a route set on the basis of position information of the destination, map information of a travel environment of the mobile apparatus 100, and self-position information of the mobile apparatus 100, for example. The mobile apparatus 100 is configured as, for example, a self-driving vehicle that goes around a predetermined route, an unmanned transportation apparatus that transports articles to a predetermined destination, or the like.

### Mobile Apparatus

First of all, a configuration of the mobile apparatus 100 will be schematically described. As shown in FIG. 1, the mobile apparatus 100 includes a first detector 11, a second detector 12, a controller 13, a drive 14, a battery 15, and the like and they are arranged in an inner or outer surface of the body 1.

The first detector 11 is a detector for acquiring information regarding the self-position and attitude of the mobile apparatus 100 (hereinafter, also referred to as self-position information). Examples of the first detector 11 can include a combination of a global positioning system (GPS) antenna and an inertial measurement unit (IMU). In addition, examples of the first detector 11 can include a camera and a technology using simultaneous localization and mapping (SLAM) for calculating the self-position on the basis of information regarding feature points of a captured image of the camera can be employed.

The second detector 12 is an detector for acquiring information regarding the position of an obstacle in a periphery of the mobile apparatus 100 (hereinafter, also referred to as obstacle map information). The obstacle set forth herein refers to a tangible object such as a person, an object, and a wall, which can be an obstacle against the movement of the mobile apparatus 100. The obstacle is not limited to a stationary obstacle, and may be a movable obstacle. The second detector 12 is typically installed on the outer surface of the body 1 of the mobile apparatus 100. For example, a laser range finder, an ultrasonic sensor, a stereo camera, or a combination thereof may be used as the second detector 12.

The controller 13 is configured as a computer (information processing apparatus) having a central processing unit (CPU), a memory, and the like. As will be described later, on the basis of the self-position information, the obstacle map information, and the like, the controller 13 plans a movement route of the mobile apparatus 100 to the destination and generates various control commands for executing it.

It should be noted that instead of or in addition to the CPU, a programmable logic device (PLD) such as a field programmable gate array (FPGA), a digital signal processor (DSP), another application specific integrated circuit (ASIC), or the like may be used.

The drive 14 includes a motor that rotates the wheels 2R and 2L, a drive circuit that drives the motor, and the like. The drive 14 individually controls rotation (direction of rotation, number of rotations, and the like) of each of the wheels 2R and 2L on the basis of a control command from the controller 13.

The battery 15 is configured as a power source for the mobile apparatus 100. The battery 15 is typically a secondary battery capable of charging and discharging. Alternatively, a solar battery or the like other than the secondary battery may be used as the battery 15.

### Information Processing Apparatus

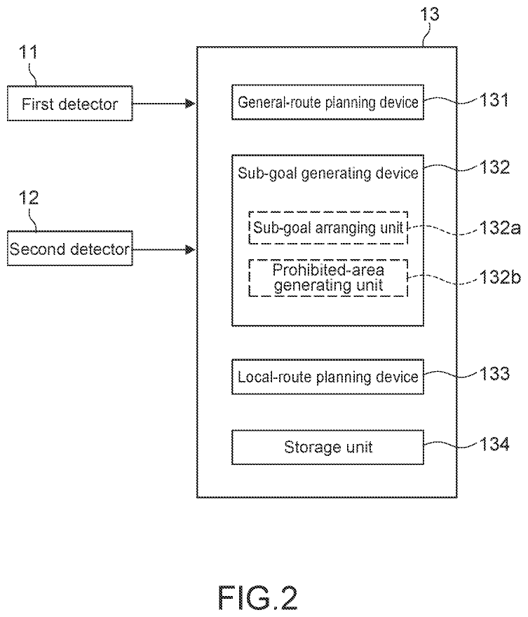

Subsequently, the controller 13 will be described in detail. FIG. 2 is a block diagram showing functions of the CPU that constitutes the controller 13.

As shown in FIG. 2, the controller 13 includes a general-route planning device 131 (general-route planning unit), a sub-goal generating device 132 (sub-goal arranging unit), a local-route planning device 133 (local-route planning unit), and a storage unit 134.

The controller 13 controls the first detector 11, the second detector 12, and the drive 14. In this embodiment, when the CPU executes a predetermined program, the general-route planning device 131, the sub-goal generating device 132, and the local-route planning device 133 as functional blocks are configured. As a matter of course, dedicated hardware such as an integrated circuit (IC) may be used in order to realize the respective blocks. The program is installed in the controller 13 via various types of storage media, for example. Alternatively, the program may be installed via the Internet or the like.

The general-route planning device 131 plans a general route to the destination on the basis of the position information of the destination (general goal). The calculation method for the general route is not particularly limited, and an appropriate route planning algorithm may be used.

The position information of the destination is set and stored in the storage unit 134 in advance together with the map information in which the destination is located. The destination prescribes both the position on the map information and the attitude of the mobile apparatus 100 when the mobile apparatus 100 arrives at the destination. The general route is not limited to a linear route, and may include bent portions and curve portions. The general-route planning device 131 generates general-route information indicating the general route and stores the general-route information in the storage unit 134. The general-route information may be embedded in the map information including the destination.

The position on the map information prescribed as the destination indicates a position set as coordinates on the map information, at which a predetermined task assigned to the mobile apparatus is performed. The predetermined task includes, for example, loading, unloading, sensing through a mounted sensor, charging, standing by for a predetermined period until a next task is assigned, and the like.

The position on the map information is typically set as coordinates of a two-dimensional space on the map information with respect to a mobile apparatus that travels the ground, and is set as coordinates of a three-dimensional space with respect to a mobile apparatus that flies. Moreover, in a case where the map information has information regarding three-dimensional coordinates, the position on the map information may be set as coordinates of a three-dimensional space even with respect to the mobile apparatus that travels the ground. Moreover, a predetermined grid-like region or space may be set.

The attitude of the mobile apparatus prescribed as the destination is typically described as a direction of the body of the mobile apparatus for the purpose as will be described below. Moreover, a yaw angle, a gyro angle, a pitch angle, a steering angle, or the like may be considered and given priority or a setting to use only them may be made.

The sub-goal generating device 132 includes a sub-goal arranging unit 132a and a prohibited-area generating unit 132b.

The sub-goal arranging unit 132a arranges a sub-goal on the basis of the position information of the set destination, the map information of the travel environment of the mobile apparatus 100, and the self-position information of the mobile apparatus 100. In this embodiment, the sub-goal arranging unit 132a is configured to generate a plurality of sub-goal candidates as sub-goals as will be described later.

The sub-goal refers an end point of a local-route plan and is for determining a reference position of the local-route plan. The sub-goal is arranged on the general route or the vicinity thereof so that the mobile apparatus 100 can arrive at the destination in a prescribed attitude. Not only the position information but also information that prescribes speed and attitude of the mobile apparatus 100 are embedded for the sub-goal. A method of setting the sub-goal is not particularly limited, and an appropriate route planning algorithm may be used. The set sub-goal is stored in the storage unit 134 as sub-goal information.

The position information of the destination is map information including the general-route information. The map information of the travel environment of the mobile apparatus 100 is map information created on the basis of information regarding the position and size of the obstacle, which is acquired by the second detector 12. The self-position information of the mobile apparatus 100 is map information regarding the self-position of the mobile apparatus 100 acquired by the first detector 11. The map information of the travel environment and the self-position information are acquired from the second detector 12 and the first detector 11 in a predetermined time cycle and stored in the storage unit 134. Such information may be successively embedded in the map information including the destination together with the general-route information.

The prohibited-area generating unit 132b generates, in at least a portion of a periphery of the destination, the prohibited area where arrangement of the sub-goal is prohibited. Accordingly, arrangement of a sub-goal that causes the mobile apparatus 100 to make a detour near the destination can be prevented. In particular, even in a case where the mobile apparatus 100 is configured as a two-wheel differential drive-type robot incapable of movement such as linear movement in a lateral direction as in this embodiment, the mobile apparatus 100 can be caused to arrive at the destination in the prescribed attitude.

The prohibited-area generating unit 132b generates the prohibited area so that the mobile apparatus 100 can arrive at the destination in the prescribed attitude. Accordingly, the mobile apparatus 100 can be caused to arrive at the destination in the prescribed attitude.

The prohibited-area generating unit 132b typically generates the prohibited area in a case where an obstacle is present on the destination. In a case where an obstacle is present on the destination, arrangement of a sub-goal that causes the mobile apparatus 100 to make a detour so as to avoid the obstacle and guides the mobile apparatus 100 to the destination is prohibited, and therefore the mobile apparatus 100 can be caused to arrive at the destination in the prescribed attitude. It should be noted that in a case where the sub-goal cannot be arranged due to generation of the prohibited area, the mobile apparatus 100 is caused to stand by (stop) at that position until the obstacle on the destination is removed. The case where the obstacle is present on the destination refers to a case where at least a portion of the obstacle is present in at least a portion of a position on the map set as a predetermined region or space.

It should be noted that in a case where the obstacle on the destination has been removed, a sub-goal that guides the mobile apparatus 100 to the destination is newly arranged. In this case, the prohibited-area generating unit may remove the prohibited area generated in the periphery of the destination.

The local-route planning device 133 plans a local route to the sub-goal on the basis of the sub-goal information generated by the sub-goal generating device 132 and prohibited area information. The planned local route is stored in the storage unit 134 as local-route information. A calculation method for the local route is not particularly limited, and an appropriate route planning algorithm can be used. The sub-goal information and the local-route information are successively generated in the predetermined time cycle until the mobile apparatus 100 arrives at a destination G.

The storage unit 134 is typically constituted by a storage device such as a semiconductor memory. The storage unit 134 stores various parameters for calculating the general route, the sub-goal, the prohibited area, and the local route in addition to the program for executing various functions of the general-route planning device 131, the sub-goal generating device 132, and the local-route planning device 133.

More specifically, the storage unit 134 stores a program that causes the controller 13 serving as the computer to execute a step of arranging the sub-goal on the basis of the position information of the set destination, the map information of the travel environment of the mobile apparatus 100, and the self-position information of the mobile apparatus 100, and a step of generating, in at least the portion of the periphery of the destination, the prohibited area where arrangement of the sub-goal is prohibited.

### Information Processing Method

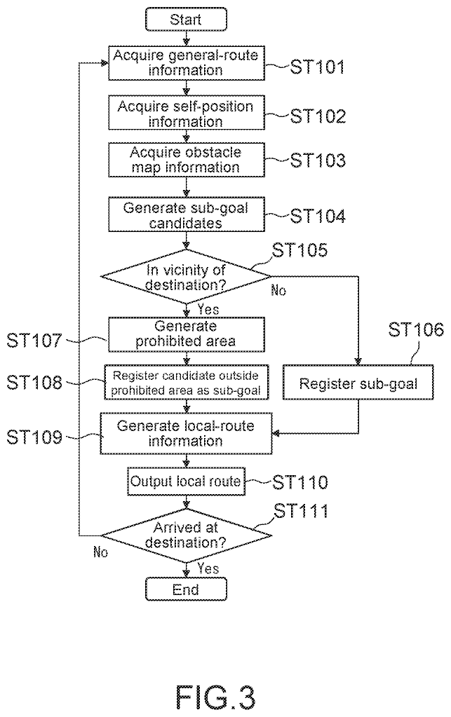

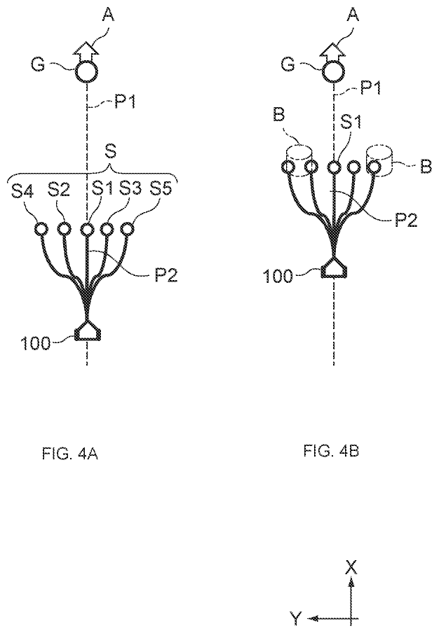

Subsequently, the controller 13 will be described in detail along with an operation of the controller 13. FIG. 3 is a flowchart showing an example of processing performed in the controller 13 and FIGS. 4 to 6 are explanatory diagrams actions of the controller 13.

The controller 13 acquires general-route information from the storage unit 134 (Step 101). The general-route information is for acquiring the position of the destination G and a generation position of a sub-goal S. The general-route information is map information indicating a route to the position of the set destination G, and includes information regarding a general route P1 determined by the general-route planning device 131 and information (indicated by the reference sign A in FIGS. 4 to 6) regarding the attitude of the mobile apparatus 100 (orientation) on the destination G. The general route P1 is determined in the general-route planning device 131 and the sub-goal S is generated in the sub-goal generating device 132 as will be described later.

Moreover, the controller 13 acquires self-position information (Step 102). The self-position information is for determining the generation position of the sub-goal and the reference position of the local-route plan. The self-position information includes information regarding the current position of the mobile apparatus 100, which is acquired by the first detector 11.

In addition, the controller 13 acquires obstacle map information (Step 103). The obstacle map information is for determining the generation position of the sub-goal S and planning the local-route that avoids the obstacle. The obstacle map information includes information regarding the position and the size of the obstacle in the periphery of the mobile apparatus 100, which are acquired by the second detector 12.

It should be noted that Steps 101 to 103 are not limited to the example in which they are performed in this order, and these steps may be simultaneously performed. The general-route information, the self-position information, and the obstacle map information may be the general route, the self-position of the mobile apparatus 100, and the position of the obstacle commonly embedded in a single map. Moreover, as will be described later, the first detector 11 and the second detector 12 acquire the self-position and the obstacle information in the predetermined time cycle, respectively. Accordingly, the self-position information and the obstacle map information are updated in accordance with the movement position of the mobile apparatus 100.

Subsequently, the controller 13 generates a plurality of sub-goal candidates (Step 104). The sub-goal generating device 132 (sub-goal arranging unit 132a) generates a plurality of sub-goal candidates S1 to S5 as shown in FIG. 4 (a). In this embodiment, the plurality of sub-goal candidates S1 to S5 is arranged in a horizontal direction (lateral direction) orthogonal to the travel direction of the mobile apparatus 100.

The sub-goal candidates S1 to S5 refer to a plurality of candidate points selected as sub-goals S. The respective sub-goal candidates S1 to S5 are prioritized. Typically, a candidate point that can provide the shortest route to the destination G is selected. The plurality of sub-goal candidates S1 to S5 generated may be stored in the storage unit 134 as the sub-goal information. The positions of the sub-goal candidates S1 to S5 are not limited to the example in which they are generated in a row in the lateral direction as described above, and the sub-goal candidates S1 to S5 may be generated in vertical and horizontal directions, for example. Sub-goal candidates can be generated following an arbitrary rule in accordance with performance for avoiding the obstacle, load for computing the sub-goal candidates, and the like. The arrangement intervals of the sub-goal candidates S1 to S5 are also not particularly limited, and, for example, can be equal to or smaller than the size of the mobile apparatus 100 (equal to or smaller than a diameter of a circle inscribed in the mobile apparatus 100). The sub-goal may also be set as the coordinates of the three-dimensional space or the predetermined grid-like region or space as in destination.

The number of sub-goal candidates S1 to S5 is not particularly limited. By setting the plurality of sub-goal candidates S1 to S5, the sub-goal S capable of avoiding the obstacle can be arranged even in a case where the obstacle is present in the periphery of the mobile apparatus 100. For example, as shown in FIG. 4 (b), in a case where the second detector 12 has detected an obstacle B on the front side of the mobile apparatus 100, sub-goal candidates that do not interfere with the obstacle B are extracted from the plurality of sub-goal candidates S1 to S5, and one sub-goal S is selected from the extracted sub-goal candidates. In this example, a sub-goal candidate S1 in the middle is selected (see FIGS. 4 (a) and (b)).

Subsequently, the controller 13 determines whether or not the mobile apparatus 100 has arrived at the vicinity of the destination G (Step 105). The vicinity of the destination G is typically set to an arbitrary position in front of the destination G as viewed from the mobile apparatus 100. The position of the mobile apparatus 100 is calculated on the basis of the self-position information according to the first detector 11.

In a case where it is determined that the mobile apparatus 100 is not yet located in the vicinity of the destination G, the sub-goal generating device 132 selects one sub-goal candidate from the sub-goal candidates S1 to S5 and registers the sub-goal candidate as the sub-goal S (Step 106). In a case where the obstacle B has been detected in the periphery of the mobile apparatus 100 on the basis of the output of the second detector 12, a sub-goal candidate that does not interfere (cause collision) with the obstacle B is selected. In this embodiment, the sub-goal candidate S1 that forms the shortest route to the destination G is selected. The registered sub-goal S (sub-goal candidate S1) is stored in the storage unit 134.

When the sub-goal S is registered, the local-route planning device 133 determines a local route P2 and generates local-route information (Step 109). The controller 13 outputs to the drive 14 a control signal for controlling the number of rotations and the directions of rotations of the wheels 2R and 2L on the basis of the generated local-route information, to thereby advance the mobile apparatus 100 at a predetermined speed and move the mobile apparatus 100 along the local route P2 (Step 110).

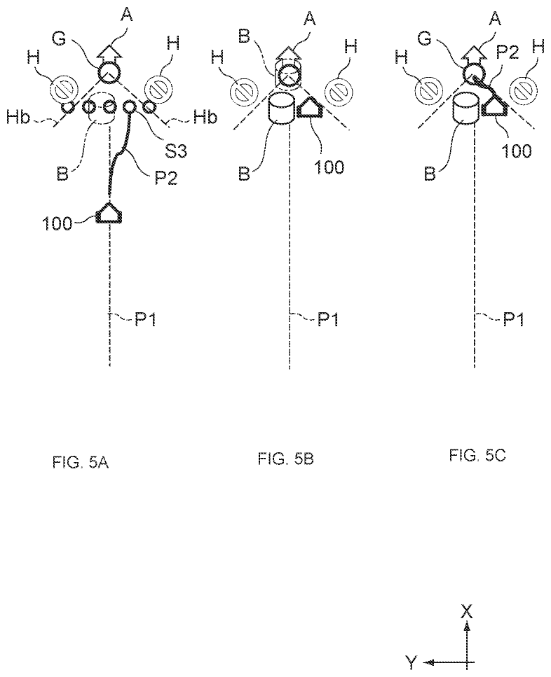

Each of the above-mentioned steps is repeatedly performed until the mobile apparatus 100 arrives at the destination (Step 111). In this case, the self-position information and the obstacle map information are acquired again from the first detector 11 and the second detector 12, respectively, and the sub-goals S (sub-goal candidates S1 to S5) and prohibited areas H (see FIG. 5) to be described later are generated on the basis of the latest information. It should be noted that in a case where the processing has shifted to Step 111 via Step 106, the mobile apparatus 100 has not reached the vicinity of the destination G, and therefore the processing always shifts to Step 101 and the above-mentioned processes are repeated.

On the other hand, when the mobile apparatus 100 arrives at the vicinity of the destination G, the controller 13 (prohibited-area generating unit 132b) generates prohibited areas H in the periphery of the destination G as shown in FIG. 5 (a) to (c) (Step 107). The prohibited areas H are regions in which arrangement of the sub-goal S is prohibited. Typically, the prohibited areas H are arranged on both the left and right sides of the destination G. Boundary portions Hb of the prohibited areas H correspond to two oblique side portions of a triangle having the destination G as its vertex as shown in FIG. 5 (a), and the upper side in the figure with respect to these oblique side portions (front side as viewed from the mobile apparatus 100) are set to be prohibited regions H. It should be noted that the boundary portions Hb are not limited to the linear ones, and may be curve partially or entirely.

The prohibited areas H are for preventing the mobile apparatus 100 from making a detour in the periphery of the destination G in order to cause the mobile apparatus 100 to arrive at the destination G in the predetermined attitude (orientation). The prohibited-area generating unit 132b is for preventing arrangement of the sub-goal S that moves the mobile apparatus 100 in a direction away from the destination G (in the figure, a negative direction on the X-axis) before the mobile apparatus 100 arrives at the destination G from the sub-goal S.

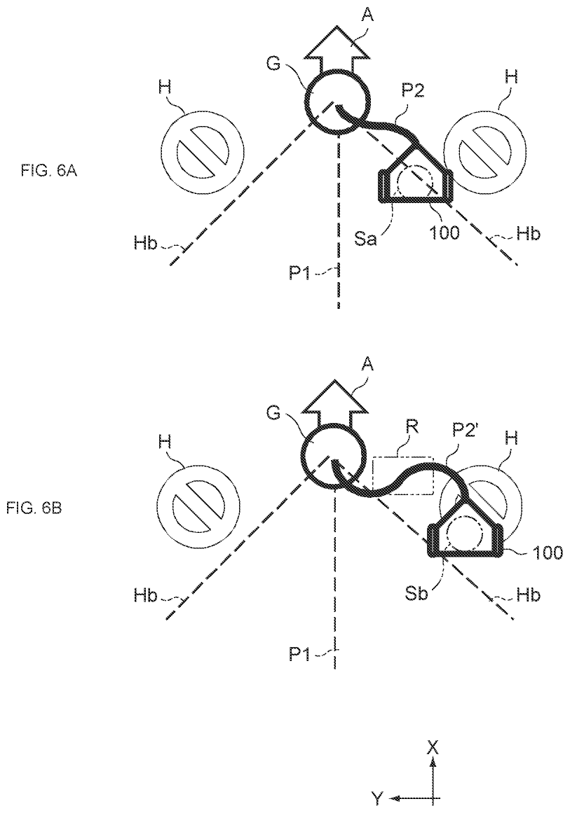

For example, as shown in FIG. 6 (a), for example, at a sub-goal Sa arranged on the boundary portion Hb of the prohibited area H, on the movement route of the mobile apparatus 100 (local route P2) to move toward the destination G from there, the mobile apparatus 100 is capable of arriving at the destination G in the prescribed attitude (orientation) A without advancing in the direction away from the destination G.

In this regard, as shown in FIG. 6 (b), for example, at a sub-goal Sb arranged within the prohibited area H, on the movement route of the mobile apparatus 100 (local route P2′) to advance toward the destination G from there, there is a region R where the mobile apparatus 100 advances in the direction away from the destination G. In this case, the mobile apparatus 100 needs to make a detour around the destination G in order to arrive at the destination G.

In view of this, in this embodiment, the prohibited-area generating unit 132b generates the prohibited areas H for prohibiting arrangement of the sub-goal Sb that requires making a detour. Accordingly, since it is possible to prevent the mobile apparatus 100 from making a detour around the destination G, it is possible to prevent the route length of the local route P2 from unnecessarily increasing and to prevent excessive inertial force (centrifugal force) from acting on the mobile apparatus 100.

The prohibited-area generating unit 132b generates the prohibited areas H on the basis of the position information of the destination G, the self-position information of the mobile apparatus 100, and the like. The number of prohibited areas H is not particularly limited, and the prohibited area H is arranged in at least a portion inside the region where the sub-goal candidates can be arranged. The size of the prohibited area H is also not particularly limited, and is set on the basis of the size, the minimum rotation radius, and the like of the mobile apparatus 100.

The sub-goal generating device 132 arranges the sub-goal S on the basis of the plurality of sub-goal candidates S1 to S5 generated in the sub-goal arranging unit 132a and the prohibited areas H generated in the prohibited-area generating unit 132b. The sub-goal generating device 132 selects a sub-goal candidate other than the sub-goal candidates, the entire areas or centers of which belong to the prohibited areas H, and registers the sub-goal candidate as a sub-goal (Step 108). Accordingly, for example, arrangement of the sub-goal such as the sub-goal Sb as shown in FIG. 6 (b) is prohibited.

It should be noted that in a case where the obstacle B is present in the periphery of the mobile apparatus 100, a sub-goal candidate (sub-goal candidate S3 in the shown example) capable of avoiding the interference (collision) with the obstacle B is selected in the sub-goal generating device 132 as shown in FIGS. 6 (a) and (b).

When the sub-goal S is registered, the local-route planning device 133 determines a local route P2 and generates local-route information (Step 109). The controller 13 outputs a control signal for controlling the number of rotations and the directions of rotations of the wheels 2R and 2L to the drive 14 on the basis of the generated local-route information, to thereby advance the mobile apparatus 100 at a predetermined speed and move the mobile apparatus 100 along the local route P2 (Step 110).

Each of the above-mentioned steps is repeatedly performed until the mobile apparatus 100 arrives at the destination (Step 111). In this case, the range of the prohibited areas H is changed dynamically (in real time) in accordance with the distance between the mobile apparatus 100 and the destination G. Accordingly, a prohibited area suitable for a general route having any shape can be generated.

In addition, in this embodiment, the prohibited-area generating unit 132b generates the prohibited areas H in a case where the obstacle B is present on the destination G. In this case, regarding the prohibited areas H, the prohibited areas H are generated in all regions in the periphery of the destination G. Moreover, the sub-goal arranging unit 132a arranges the sub-goal so that the mobile apparatus 100 stands by (stops) in front of the destination G until the obstacle B on the destination G is removed as shown in FIG. 5 (b). In a case where it has been detected that the obstacle B has been removed from the destination G, then the mobile apparatus 100 is advanced toward the destination G as shown in FIG. 5 (c). At this time, the prohibited-area generating unit 132b may remove the generated prohibited areas H.

### Modified Examples

In the above-mentioned embodiment, the example in which the controller 13 is provided in the mobile apparatus 100 has been described, though the controller 13 may be installed in a place other than the mobile apparatus 100. In this case, control information such as the general-route information, the sub-goal information, the prohibited area information, and the local-route information with respect to the mobile apparatus 100 is sent to the controller 13 via wireless communication. Moreover, in this case, the controller 13 may be configured to control the movement of a plurality of mobile apparatuses 100.

Moreover, in the above-mentioned embodiment, the prohibited areas H are generated when the mobile apparatus 100 arrives at the vicinity of the destination G and the prohibited areas are re-generated in accordance with the distance between the mobile apparatus 100 and the destination G, though the prohibited areas H may be fixedly generated. In this case, since the prohibited areas are set before the mobile apparatus 100 arrives at the vicinity of the destination, the computing load at the time of generating the prohibited areas can be reduced.

In addition, in the above-mentioned embodiment, the present technology is not limited to the case where the prohibited areas H are generated only in the periphery of the destination G. For example, an area where the user is not allowed to voluntarily travel can also be generated as a prohibited area. For example, in a case where the mobile apparatus is a self-driving vehicle (automobile) travelling on ordinary roads, a prohibited area can be set to restrict arrangement of a sub-goal that causes the vehicle to move out of the traffic lane in a no passing zone.

It should be noted that the present technology may also take the following configurations.

(1) An information processing apparatus, including:

a sub-goal arranging unit that arranges a sub-goal on the basis of position information of a set destination, map information of a travel environment of a mobile apparatus, and self-position information of the mobile apparatus; and

a prohibited-area generating unit that generates, in at least a portion of a periphery of the destination, a prohibited area where arrangement of the sub-goal is prohibited.

(2) The information processing apparatus according to (1), in which

the prohibited-area generating unit generates the prohibited area in a case where an obstacle is present on the destination.

(3) The information processing apparatus according to (2), in which

the prohibited-area generating unit removes the prohibited area in a case where an obstacle on the destination has been removed.

(4) The information processing apparatus according to any one of (1) to (3), in which

the prohibited-area generating unit generates the prohibited area so that a sub-goal that moves the mobile apparatus in a direction away from the destination before the mobile apparatus arrives at the destination from the sub-goal is not arranged.

(5) The information processing apparatus according to any one of (1) to (4), in which

the prohibited-area generating unit generates the prohibited area so that the mobile apparatus is capable of arriving at the destination in a prescribed attitude.

(6) The information processing apparatus according to any one of (1) to (5), further including:

a general-route planning unit that plans a general route to the destination on the basis of the position information of the destination; and

a local-route planning unit that plans a local route to the sub-goal arranged by the sub-goal arranging unit.

(7) The information processing apparatus according to (6), in which

the sub-goal arranging unit generates a plurality of sub-goal candidates arranged in a horizontal direction orthogonal to a travel direction of the mobile apparatus as the sub-goal, and

the local-route planning unit selects one sub-goal candidate from the plurality of sub-goal candidates.

(8) The information processing apparatus according to (7), in which

the local-route planning unit selects a sub-goal candidate of the plurality of sub-goal candidates, which provides a shortest route to the destination.

(9) The information processing apparatus according to any one of (1) to (8), in which

the information processing apparatus is provided in the mobile apparatus.

(10) An information processing method, including:

arranging a sub-goal on the basis of position information of a set destination, map information of a travel environment of a mobile apparatus, and self-position information of the mobile apparatus; and

generating, in at least a portion of a periphery of the destination, a prohibited area where arrangement of the sub-goal is prohibited.

(11) A program that causes a computer to execute:

a step of arranging a sub-goal on the basis of position information of a set destination, map information of a travel environment of a mobile apparatus, and self-position information of the mobile apparatus; and

a step of generating, in at least a portion of a periphery of the destination, a prohibited area where arrangement of the sub-goal is prohibited.

### REFERENCE SIGNS LIST

11 first detector
12 second detector
13 controller
14 drive
100 mobile apparatus
131 general-route planning device
132 sub-goal generating device
132a sub-goal arranging unit
132b prohibited-area generating unit
133 local-route planning device
134 storage unit
B obstacle
G destination
H prohibited area
P1 general route
P2 local route
S sub-goal
S1 to S5 sub-goal candidate

1. An information processing apparatus, comprising:
a sub-goal arranging unit that arranges a sub-goal on a basis of position information of a set destination, map information of a travel environment of a mobile apparatus, and self-position information of the mobile apparatus; and
a prohibited-area generating unit that generates, in at least a portion of a periphery of the destination, a prohibited area where arrangement of the sub-goal is prohibited.

2. The information processing apparatus according to claim 1, wherein
the prohibited-area generating unit generates the prohibited area in a case where an obstacle is present on the destination.

3. The information processing apparatus according to claim 2, wherein
the prohibited-area generating unit removes the prohibited area in a case where an obstacle on the destination has been removed.

4. The information processing apparatus according to claim 1, wherein
the prohibited-area generating unit generates the prohibited area so that a sub-goal that moves the mobile apparatus in a direction away from the destination before the mobile apparatus arrives at the destination from the sub-goal is not arranged.

5. The information processing apparatus according to claim 1, wherein
the prohibited-area generating unit generates the prohibited area so that the mobile apparatus is capable of arriving at the destination in a prescribed attitude.

6. The information processing apparatus according to claim 1, further comprising:
a general-route planning unit that plans a general route to the destination on a basis of the position information of the destination; and
a local-route planning unit that plans a local route to the sub-goal arranged by the sub-goal arranging unit.

7. The information processing apparatus according to claim 6, wherein
the sub-goal arranging unit generates a plurality of sub-goal candidates arranged in a horizontal direction orthogonal to a travel direction of the mobile apparatus as the sub-goal, and
the local-route planning unit selects one sub-goal candidate from the plurality of sub-goal candidates.

8. The information processing apparatus according to claim 7, wherein
the local-route planning unit selects a sub-goal candidate of the plurality of sub-goal candidates, which provides a shortest route to the destination.

9. The information processing apparatus according to claim 1, wherein
the information processing apparatus is provided in the mobile apparatus.

10. An information processing method, comprising:
arranging a sub-goal on a basis of position information of a set destination, map information of a travel environment of a mobile apparatus, and self-position information of the mobile apparatus; and
generating, in at least a portion of a periphery of the destination, a prohibited area where arrangement of the sub-goal is prohibited.

11. A program that causes a computer to execute:
a step of arranging a sub-goal on a basis of position information of a set destination, map information of a travel environment of a mobile apparatus, and self-position information of the mobile apparatus; and
a step of generating, in at least a portion of a periphery of the destination, a prohibited area where arrangement of the sub-goal is prohibited.
